(19) United States
(12) Patent Application Publication
(10) Pub. No.: US 2021/0016853 A1
(43) Pub. Date: Jan. 21, 2021

(54) TRICYCLE-FRAME ADJUSTMENT STRUCTURE

(71) Applicant: Ping-Lin Yu, New Taipei City (TW)

(72) Inventor: Ping-Lin Yu, New Taipei City (TW)

(21) Appl. No.: 16/514,969

(22) Filed: Jul. 17, 2019

(51) Int. Cl. B62K 15/00; B62K 5/06; B62J 9/00

(52) U.S. Cl. CPC B62K 15/00; B62K 5/06; B62K 2206/00; B62K 2015/001; B62J 9/00

(57) ABSTRACT

The main structure of the present invention comprises: a carrying-frame set with a cargo-carrying structure, direction-guiding wheels, and a connection component comprising a sleeving-connection element and a quick-dismantling component; wherein the connection component is provided for connecting a power-providing frame set with an adjustment component comprising an assembly-connection element and a connection portion, and a steering component is set at the side of the connection component. Thereby, the user can adjust the distance between the carrying-frame and the power-providing frame to achieve the advantage of saving the accommodation space through the steering component.

### TECHNICAL FIELD OF THE INVENTION

The present invention is a tricycle frame adjustment structure that can be adjusted according to the user's body shape and is convenient for accommodation and parking.

### DESCRIPTION OF THE PRIOR ART

In a typical tricycle, the distance between the sitting position of the driver and the position of the cargo-carrying is fixed, and there is no way to adjust according to the stature of the driver. Therefore, it is quite inconvenient for the driver being too tall or short in using.

Furthermore, the volume used for the cargo-carrying part is usually not too small for a tricycle having a type of cargo-carrying. If the driving position volume is added, the overall volume will be too large, so it is easy to produce the bother of not finding the position to accommodate when accommodating or parking.

### SUMMARY OF THE INVENTION

The main structure of the present invention comprises: a carrying-frame, direction-guiding wheels pivotally set on the carrying-frame, a connection component set at the side of the carrying-frame, a power-providing frame connected with the connection component, an adjustment component provided for connecting with the connection component, and a steering component set on the carrying-frame; wherein the connection component comprises a sleeving-connection element set at the side of the carrying-frame and a quick-dismantling component set on the sleeving-connection element; wherein the adjustment component comprises a assembly-connection element set at the side of the power-providing frame and a connection portion set on the assembly-connection element.

Through the above-mentioned structure, the user can penetrate the assembly-connection element of the adjustment component into the sleeving-connection element of the connection component; and the user can select any one of the connection portion to align with the position of the quick-dismantling component, thereby adjusting the distance between the power-providing frame and the carrying-frame to match the body shape of various users. After adjusting the distance, the quick-dismantling component and one of the connection portion are connected to each other, thereby connecting the carrying-frame and the power-providing frame to each other through the connection component and the adjustment component; and then pushing the carrying-frame through the power-providing frame, so that each direction-guiding wheel rotates to drive the tricycle to move.

When it is to be accommodated, the angle between the power-providing frame and the carrying-frame can be changed through the steering component, thereby reducing the volume occupied by the whole body; and the tricycle can be parked and accommodated in a narrower place to improve the convenience of the whole use.

### BRIEF DESCRIPTION OF THE DRAWINGS

FIG. 1 is a stereo diagram of the preferred embodiment of the present invention.

FIG. 2 is an exploded diagram of the preferred embodiment of the present invention.

FIG. 3 is a structural block schematic diagram of the preferred embodiment of the present invention.

FIG. 4 is a connection and adjustment schematic diagram of the preferred embodiment of the present invention.

FIG. 5 is a fixing schematic diagram 1 of the preferred embodiment of the present invention.

FIG. 6 is a fixing schematic diagram 2 of the preferred embodiment of the present invention.

FIG. 7 is a fixing schematic diagram 3 of the preferred embodiment of the present invention.

FIG. 8 is a releasing schematic diagram of the preferred embodiment of the present invention.

FIG. 9 is a folding schematic diagram of the preferred embodiment of the present invention.

FIG. 10 is a position-limit schematic diagram 1 of the preferred embodiment of the present invention.

FIG. 11 is a position-limit schematic diagram 2 of the preferred embodiment of the present invention.

FIG. 12 is a stereo diagram of the other preferred embodiment of the present invention.

FIG. 13 is a fixing schematic diagram of the other preferred embodiment of the present invention.

FIG. 14 is a tricycle-frame replacement schematic diagram of another preferred embodiment of the present invention.

FIG. 15 is a using-state diagram of another preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims

The foregoing and other aspects, features, and utilities of the present invention will be best understood from the following detailed description of the preferred embodiments when read in conjunction with the accompanying drawings.

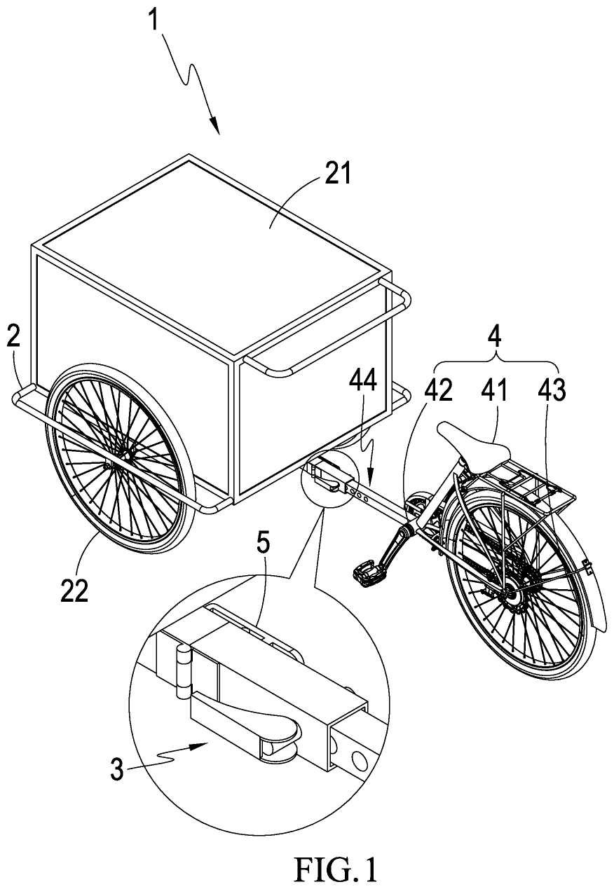

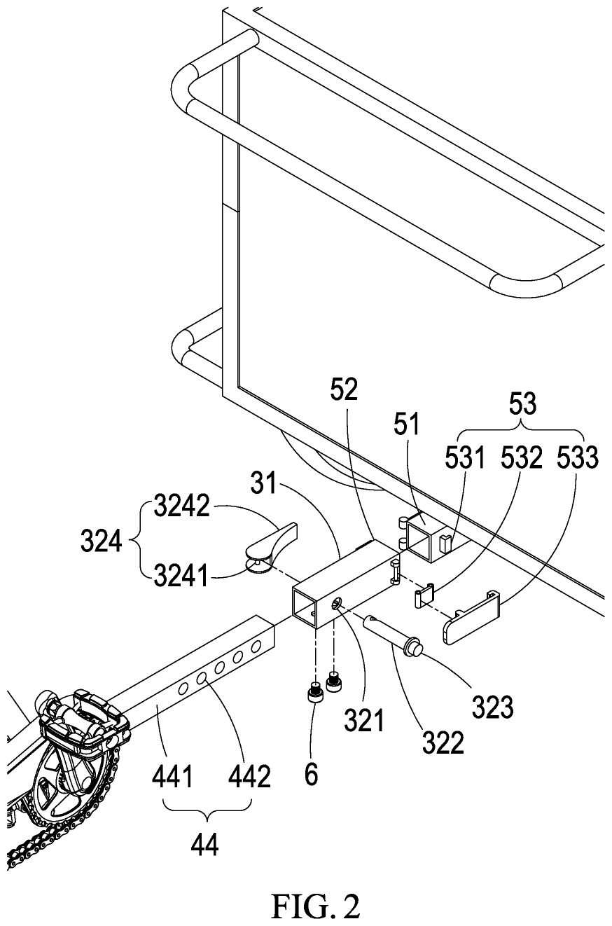

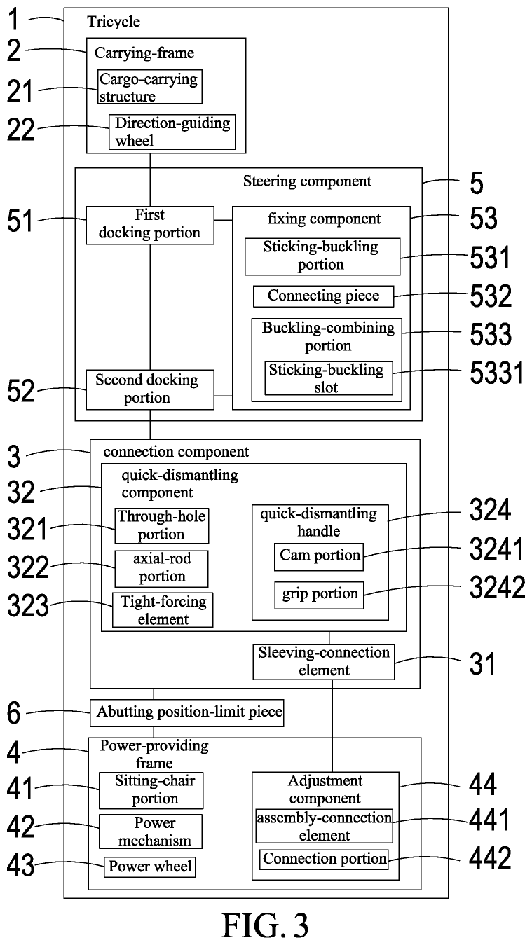

Please refer to FIG. 1 to FIG. 3, it can be clearly seen that the tricycle 1 of the present invention comprises: a carrying-frame 2; at least one cargo-carrying structure 21 set on the carrying-frame 2, wherein the cargo-carrying structure 21 of the present embodiment is exemplified by a box set on the carrying-frame 2; at least one connection component 3 set at the side of the carrying-frame 2, wherein the connection component 3 comprises a sleeving-connection element 31 set at the side of the carrying-frame 2 and a quick-dismantling component 32 set on the sleeving-connection element 31; wherein the quick-dismantling component 32 has a plurality of through-hole portions 321 set at two opposite sides of the sleeving-connection element 31, a axial-rod portion 322 set and pass through each of the through-hole portions 321, at least one tight-forcing element 323 set at one end of the axial-rod portion 322, and a quick-dismantling handle 324 set at the other end of the s axial-rod portion 322; wherein the quick-dismantling handle 324 has a cam portion 3241 pivotally set on the axial-rod portion 322 and a grip portion 3242 formed at the side of the cam portion 3241; a power-providing frame 4 detachably connected with the connection component 3, wherein the power-providing frame 4 has a sitting-chair portion 41 connected with the connection component 3, a power mechanism 42 set on the sitting-chair portion 41, and a power wheel 43 pivotally set on the sitting-chair portion 41; wherein the power mechanism 42 is exemplified by the stepping power structure of the bicycle in the present embodiment, but it is not limited thereto, which an electric motor or a fuel mechanism may be used as the power mechanism 42; at least one adjustment component 44 set on the power-providing frame 4 for the power-providing frame 4 to be connected with the connection component 3, wherein the adjustment component 44 comprises a assembly-connection element 441 set at the side of the power-providing frame 4 and a plurality of connection portions 442 set on the assembly-connection element 441; wherein the assembly-connection element 441 can penetrate into the sleeving-connection element 31, and each connection portion 442 is a through-hole in the present embodiment which each axial-rod portion 322 can pass through; at least one steering component 5 set on the carrying-frame 2, wherein the steering component 5 comprises a first docking portion 51 set on the carrying-frame 2, a second docking portion 52 pivotally connected with the first docking portion 51, and a fixing component 53 set between the first docking portion 51 and the second docking portion 52; wherein the fixing component 53 comprises a sticking-buckling portion 531, a connecting piece 532, and a buckling-combining portion 533; wherein the sticking-buckling portion 531 is set on the first docking portion 51 and one end of the connecting piece 532 is pivotally connected with the second docking portion 52, and the buckling-combining portion 533 is pivotally connected with the other end of the connecting piece 532; wherein the buckling-combining portion 533 has a sticking-buckling slot 5331 adjacent to one side of the sticking-buckling portion 531 for fastening with the sticking-buckling portion 531; and a plurality of abutting position-limit pieces 6 penetrated and set on the sleeving-connection element 31, wherein the abutting position-limit piece 6 is a screw that is locked and combined with the sleeving-connection element 31 provided for butting, penetrating, and setting with the assembly-connection element 441 in the sleeving-connection element 31 for position-limit in this embodiment, but it is not limited to; it can also be set without the abutting position-limit piece 6.

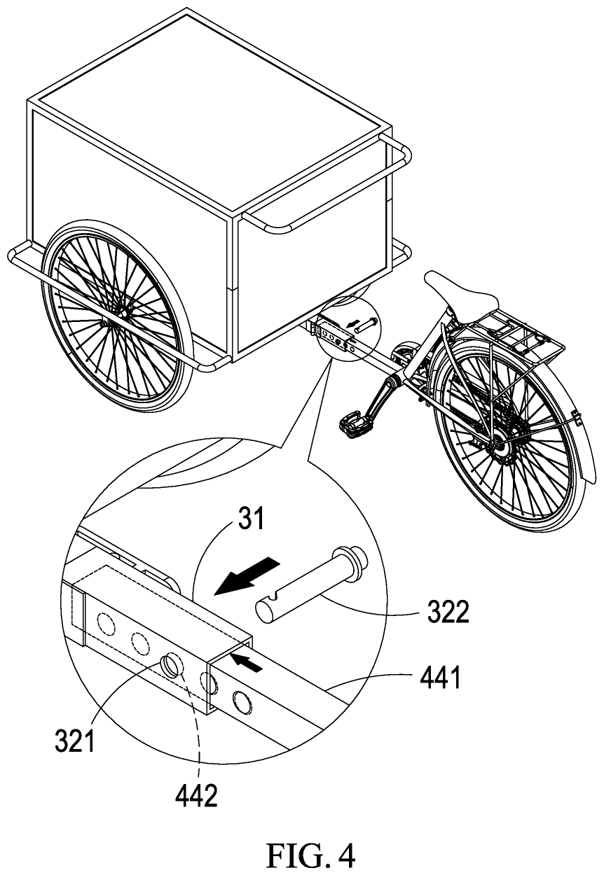

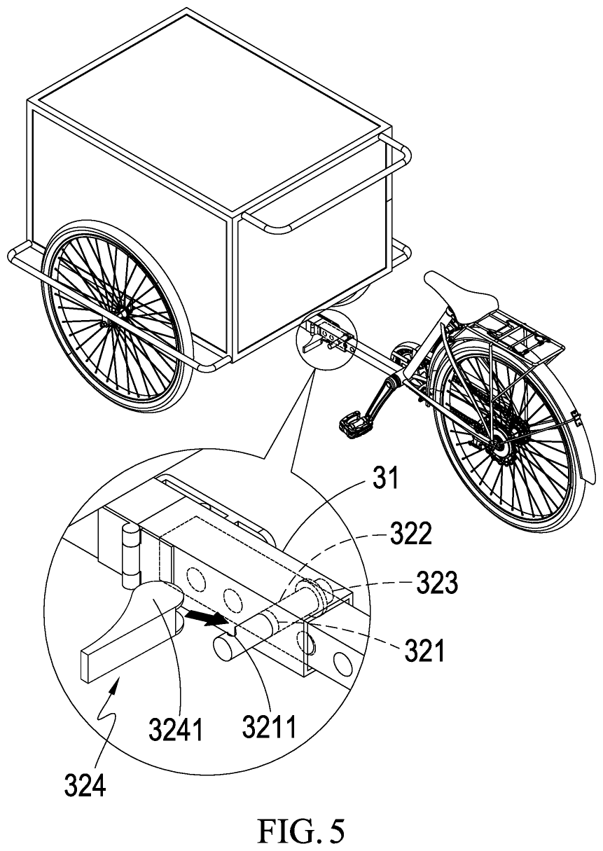

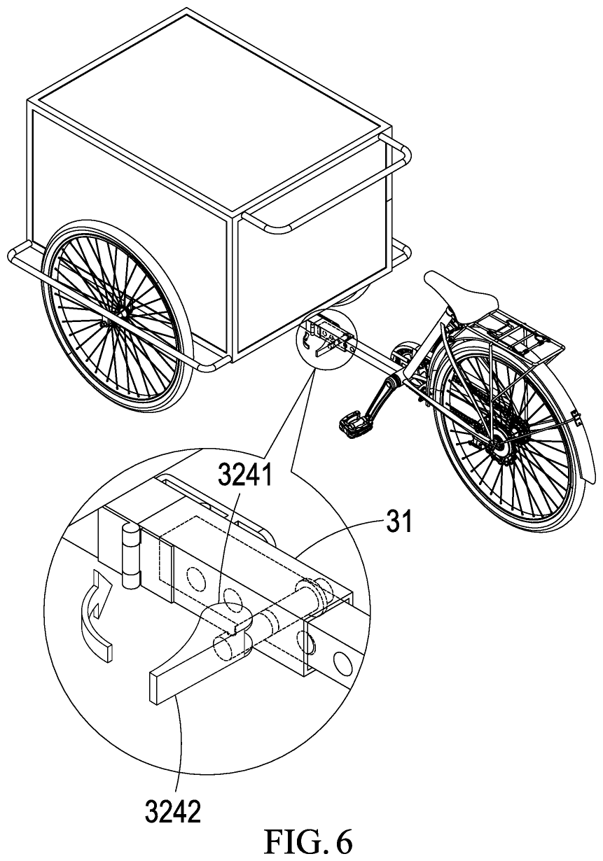

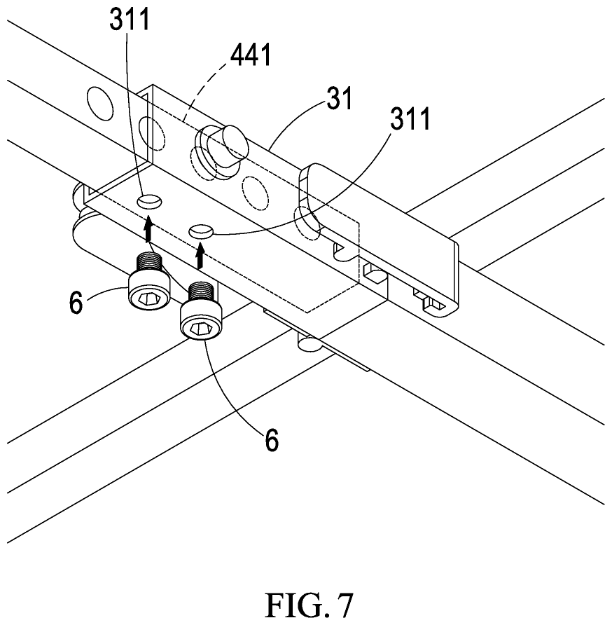

Please simultaneously refer to FIG. 1 to FIG. 11, the user can first insert the assembly-connection element 441 of the adjustment component 44 into the sleeving-connection element 31 in the connection component 3 and allow the assembly-connection element 441 to telescopically move within the sleeving-connection element 31 to be in accordance with the user's body shape to adjust the distance between the power-providing frame 4 and the carrying-frame 2; after confirming the distance, the connection portions 442 closest to the through-hole portions 321 can be aligned with the positions of the through-hole portions 321; and as shown in FIG. 4, the axial-rod portion 322 can be simultaneously passed through each of the through-hole portions 321 and one of the connection portions 442 thereof; therefore, the assembly-connection element 441 can no longer move telescopically in the sleeving-connection element 31; please continuously refer to FIG. 5, after the axial-rod portion 322 passes through each of the through-hole portions 321, the tight-forcing element 323 will abut on the sleeving-connection element 31 (the tight-forcing element 323 of this embodiment is exemplified by a plastic gasket, but it is not limited); and the user can then engage the quick-dismantling handle 324 at one end of the axial-rod portion 322 (this embodiment is to engage the cam portion 3241 of the quick-dismantling handle 324 with the concave slot 3211 of the end of the axial-rod portion 322 as an example); thereby the quick-dismantling handle 324 can be mounted on the axial-rod portion 322; please further refer to FIG. 6, through the cam portion 3241 abuts with sleeving-connection element 31 and in cooperation with the effect of the tight-forcing element 323, pushing the position of the grip portion 3242, the quick-dismantling component 32 can be fixed to the sleeving-connection element 31; and the distance between the power-providing frame 4 and the carrying-frame 2 can be fixed; and then, each abutting position-limit piece 6 is locked into the sleeving-connection element 31; thereby the abutting position-limit piece 6 abuts with the assembly-connection element 441; because the abutting position-limit piece 6 is connected with the lock hole 311 of the sleeving-connection element 31 in the form of a thread locking in this embodiment, so that the locking depth of the abutting position-limit piece 6 can be adjusted; thereby the tightness against the limit of the assembly-connection element 441 can be adjusted to enhance the overall fixing effect, so that the user can step the power mechanism 42 on the sitting-chair portion 41 to drive the power wheel 43 to rotate, thereby pushing the direction-guiding wheels 22 to rotate to move the tricycle 1.

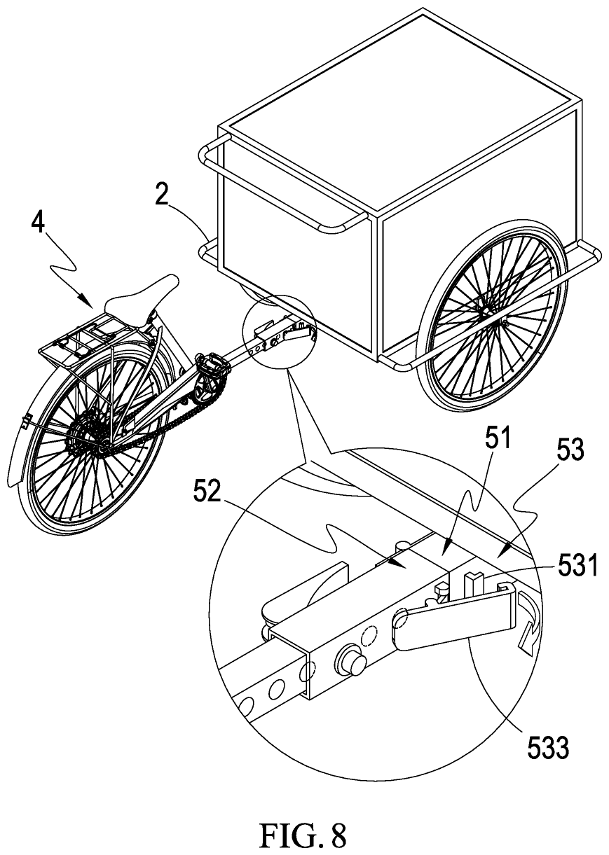

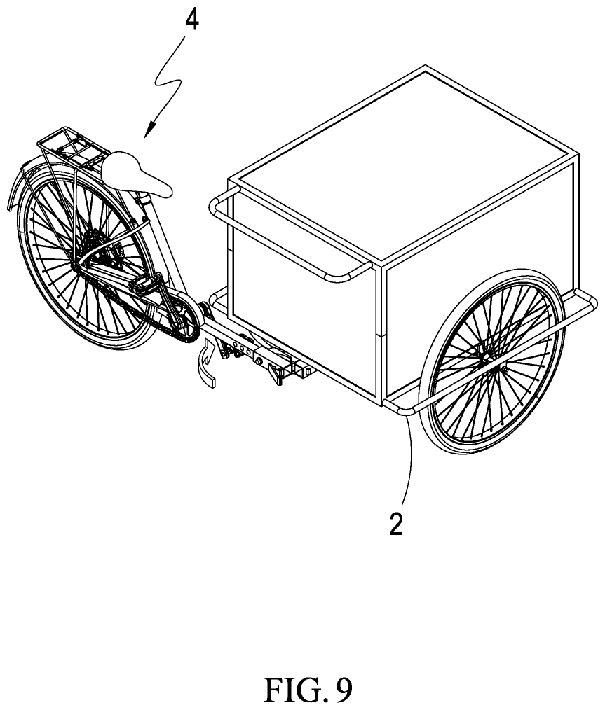

If wanting to park and accommodate, the quick-dismantling component 32 can be removed to separate the power-providing frame 4 and the carrying-frame 2 from each other for separate accommodation and parking; alternatively, as shown in FIG. 8 and FIG. 9, the user can pull the buckling-combining portion 533 of the fixing component 53 and disengage the buckling-combining portion 533 from the sticking-buckling portion 531 to allow the first docking portion 51 and the second docking portion 52 pivotally swing to each other; thereby changing the positional relationship between the power-providing frame 4 and the carrying-frame 2 to shorten the overall length. This method can be achieved simply by opening the fixing component 53, which is faster and simpler than pulling out the power-providing frame 4 after removing the quick-dismantling component 32; and which can improve the convenience of use.

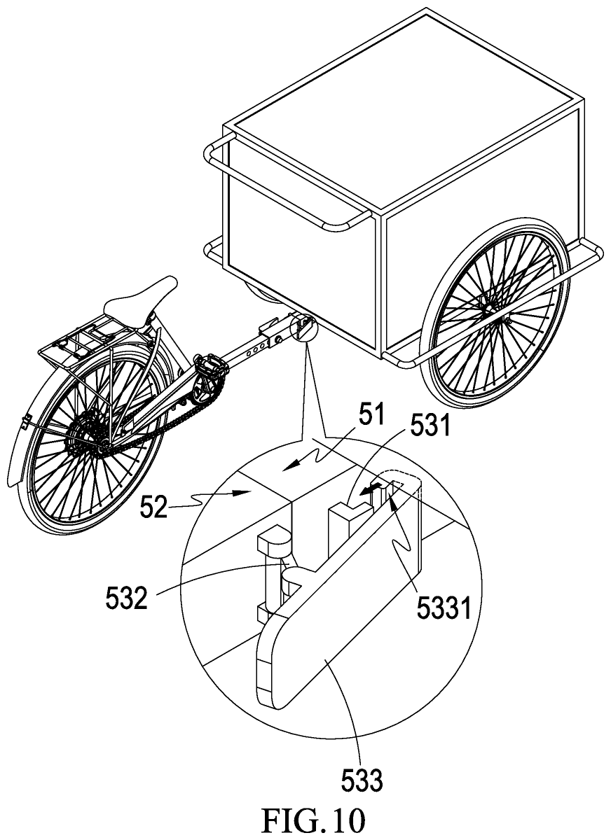

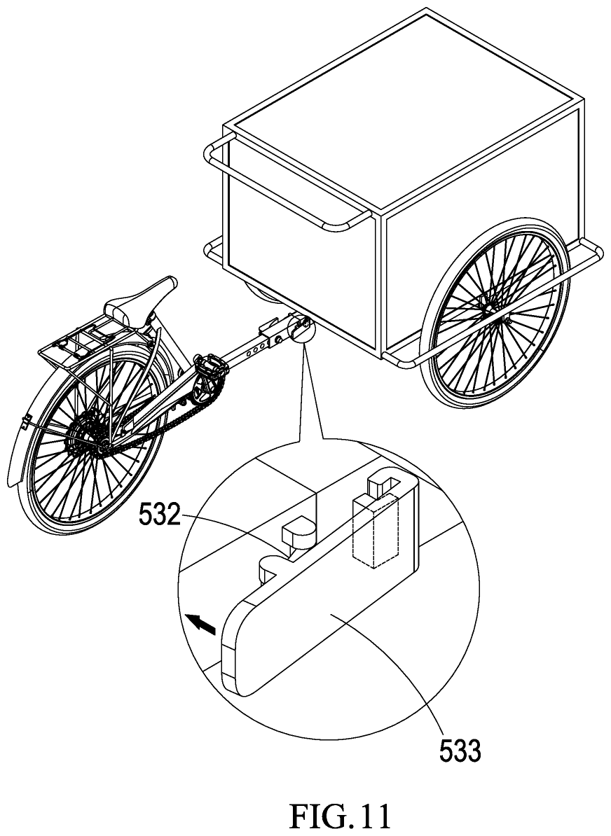

Moreover, when the user wants to continue to use the mobile tricycle 1 to move, as shown in FIG. 10 and FIG. 11, the first docking portion 51 and the second docking portion 52 can be aligned with each other; then, the sticking-buckling slot 5331 of the buckling-combining portion 533 which can be buckled and combined with the sticking-buckling portion 531 is pushed via the swing effect of the connecting piece 532 to penetrate into the sticking-buckling portion 531 (the sticking-buckling portion 531 in the embodiment is a concave slot being able to be buckled and combined with the sticking-buckling slot 5331 correspondingly); and then, pressing down the other end of the buckling-combining portion 533 which faces away from the sticking-buckling slot 5331; at this time, the connecting piece 532 will make a swing movement using the pivot point pivotally connected with the second docking portion 52 as an axis; and the connecting piece 532 is made to close to the second docking portion 52, which will also bring the buckling-combining portion 533 to be close to the second docking portion 52; and, when the buckling-combining portion 533 is close to the second docking portion 52, the sticking-buckling slot 5331 can change the support length of the connecting piece 532 through changing the angle of the connecting piece 532; thereby gradually engaging into the ticking-buckling portion 531. When the buckling-combining portion 533 is abutted and combined with the second docking portion 52, the sticking-buckling slot 5331 can be completely engaged and fixed on the sticking-buckling portion 531 through the supporting force provided by the connecting piece 532; therefore the mutual position of the power-providing frame 4 and the carrying-frame 2 can be fixed through the buckling-combining portion 533 to allow the user to continue to use the tricycle 1.

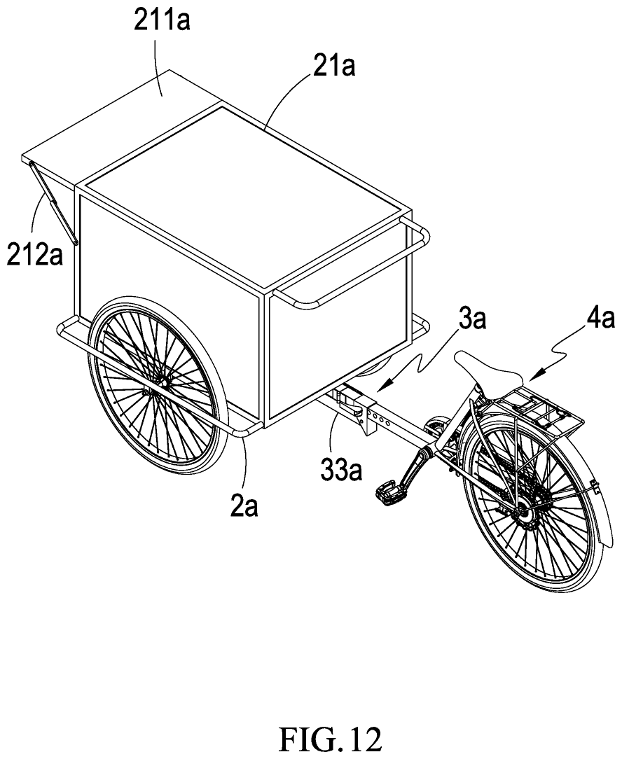

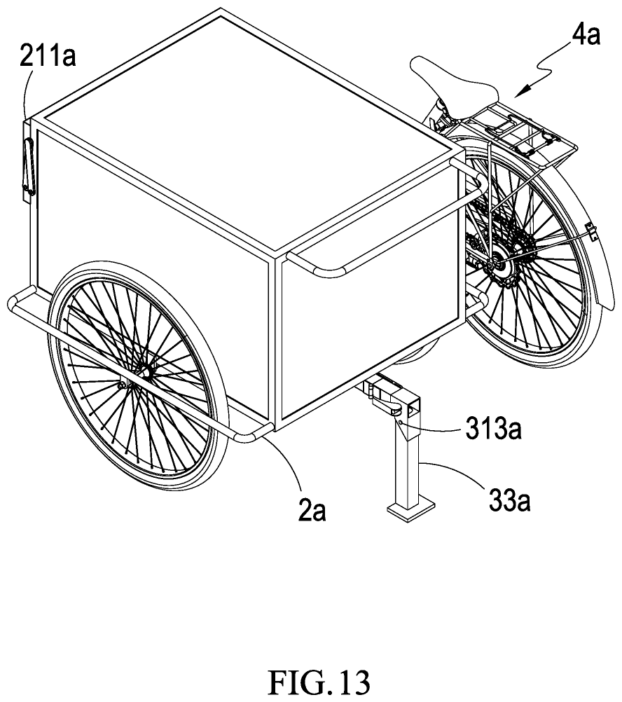

Please simultaneously refer to FIG. 12 and FIG. 13, in this embodiment, a folding table 211a is set on the cargo-carrying structure 21a; and an auxiliary device 33a is set at the side of the connection component 3a; the auxiliary device 33a of this embodiment takes a support stand pivotally connected with the connection component 3a as an example; wherein the auxiliary device 33a is connected with the connection component 3a through a pivotal fulcrum 331a and is pivotally rotated through the pivotal fulcrum 331a. Therefore, after the user disengages the power-providing frame 4a from the carrying-frame 2a, the auxiliary device 33a can still be pulled to swing the auxiliary device 33a to the upright state, thereby stably supporting the carrying-frame 2a through the auxiliary device 33a; at the same time, the folding table 211a can be lifted up and supported by the linking-rod structure 212a connected between the folding table 211a and the cargo-carrying structure 21a; thereby engaging the folding table 211a for the action of selling, and so as to improve the convenience of use.

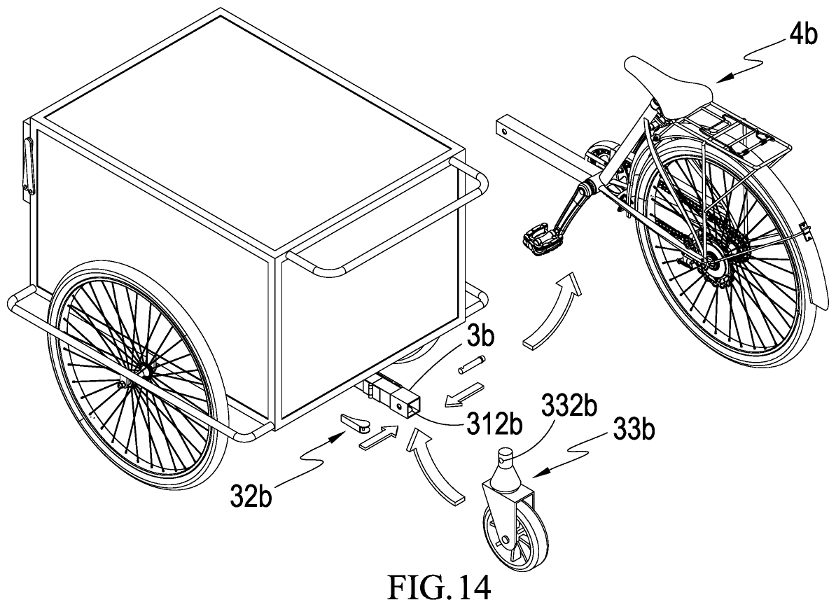

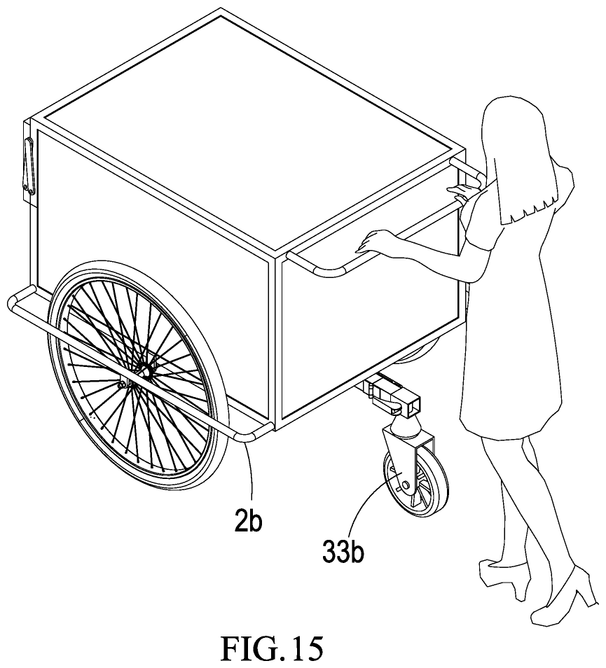

Please simultaneously refer to FIG. 14 and FIG. 15, in this embodiment, the user can remove the power-providing frame 4b and fix the auxiliary device 33b to the connection component 3b through the quick-dismantling component 32b; wherein the auxiliary device 33b in this embodiment is exemplified by an auxiliary wheel, and the sleeving-connection element 31b has an auxiliary through-hole 312b for allowing the auxiliary device 33b to partially penetrate into; and the auxiliary device 33b has a through-hole 332b at a side of penetrating the auxiliary through-hole 312b; so that the user can partially penetrate the auxiliary device 33b into the auxiliary through-hole 312b, and then penetrate the quick-dismantling component 32b into the through-hole 332b to combine; thereby, the auxiliary device 33b is fixed with the sleeving-connection element 31b; and the user can be in cooperation with the auxiliary device 33b to directly push the carrying-frame 2b to move, which can improve the convenience of use again.

I claim:

1. A tricycle-frame adjustment structure, wherein the tricycle mainly comprises:
a carrying-frame;
a plurality of direction-guiding wheels pivotally set on the carrying-frame;
at least one connection component set at one side of the carrying-frame, wherein the connection component comprises a sleeving-connection element and a quick-dismantling component;
wherein the sleeving-connection element is set at one side of the carrying-frame and the quick-dismantling component is set on the sleeving-connection element;
at least one adjustment component set on the power-providing frame and provided for the power-providing frame to be connected with the connection component, wherein the adjustment component comprises a assembly-connection element and a plurality of connection portions;
wherein the assembly-connection element is set at on the power-providing frame provided for penetrating into the sleeving-connection element, and the connection portions are set at on the assembly-connection element;
wherein each of the assembly-connection element is respectively fixed correspondingly through the quick-dismantling component to adjust the distance between the power-providing frame and the carrying-frame; and
at least one steering component set on the carrying-frame and located at one side of the connection component.

2. The tricycle-frame adjustment structure according to claim 1, wherein the steering component comprises a first docking portion, a second docking portion, and a fixing component; wherein the first docking portion is set on the carrying-frame and the second docking portion is pivotally connected with the first docking portion, and the connection component is set one side of the second docking portion; wherein the fixing component is set between the first docking portion and the second docking portion and is provided for fixing the first docking portion and the second docking portion.

3. The tricycle-frame adjustment structure according to claim 2, wherein the fixing component comprises a sticking-buckling portion, a buckling-combining portion, and a connecting piece; wherein the sticking-buckling portion is set on the first docking portion, and one end of the connecting piece is pivotally connected with the second docking portion; wherein the sticking-buckling portion is pivotally set connected with one end of the connecting piece facing away from the second docking portion, and the side adjacent to one side of the sticking-buckling portion is provided for fastening with the sticking-buckling portion.

4. The tricycle-frame adjustment structure according to claim 1, wherein the power-providing frame has a sitting-chair portion, a power mechanism, and a power wheel; wherein the adjustment component is set on the sitting-chair portion, and the sitting-chair portion is connected with the connection component through the adjustment component; wherein the power wheel is pivotally set on the sitting-chair portion, and the power mechanism is also set on the sitting-chair portion to drive the power wheel to rotate through the power mechanism.

5. The tricycle-frame adjustment structure according to claim 4, wherein the quick-dismantling component comprises a plurality of through-hole portions, a axial-rod portion, at least one tight-forcing element, and a quick-dismantling handle; wherein the through-hole portions are respectively set at different sides of the sleeving-connection element, and the axial-rod portion is simultaneously penetrated and set on each of the through-hole portions and the connection portion; wherein the tight-forcing element is set at one side of the axial-rod portion, and the quick-dismantling handle is set at the other side of the axial-rod portion.

6. The tricycle-frame adjustment structure according to claim 5, wherein the quick-dismantling handle has a cam portion pivotally set on the axial-rod portion and a grip portion formed at one side of the cam portion.

7. The tricycle-frame adjustment structure according to claim 1, wherein at least one abutting position-limit piece is penetrated and set on the sleeving-connection element to provide for abutting and position-limiting the assembly-connection element.

8. The tricycle-frame adjustment structure according to claim 1, wherein at least one cargo-carrying structure is set on the carrying-frame.

9. The tricycle-frame adjustment structure according to claim 8, wherein a folding table is movably set on the cargo-carrying structure.

10. The tricycle-frame adjustment structure according to claim 1, wherein an auxiliary device is set at the side of the connection component, which the auxiliary device worked together with the direction-guiding wheels is provided for maintaining the balance of the carrying-frame.
